(19) United States
(12) Patent Application Publication
(10) Pub. No.: US 2010/0056184 A1
(43) Pub. Date: Mar. 4, 2010

(54) PRESENCE-AWARE CELLULAR COMMUNICATION SYSTEM AND METHOD

(75) Inventors: Faramak Vakil, Long Grove, IL (US); Dragan M. Boscovic, South Barrington, IL (US)

Correspondence Address: MOTOROLA, INC., 1303 EAST ALGONQUIN ROAD, IL01/3RD, SCHAUMBURG, IL, 60196, US

(73) Assignee: MOTOROLA, INC., Schaumburg, IL (US)

(21) Appl. No.: 12/198,442

(22) Filed: Aug. 26, 2008

(51) Int. Cl. H04Q 7/20

(52) U.S. Cl. 455/456.5

(57) ABSTRACT

A cellular communication system comprises a network supporting user equipment over an air interface, the network having a hierarchical cell arrangement with overlay cells and underlay cells. An underlay base station is associated with a subset of registered user equipment. An activation server switches the underlay base station between an inactive mode and an active mode in response to detecting that registered user equipment meets a location criterion. The underlay base station only supports user equipment when in the active mode, e.g., it may only transmit a pilot signal in this mode. Interference and power consumption may be substantially reduced by sending the base station into the inactive mode thereby resulting in increased capacity of the cellular communication system as a whole.

### FIELD OF THE INVENTION

The invention relates generally to cellular communications and particularly, but not exclusively, to a cellular communication system deploying pico-cells or femto-cells.

### BACKGROUND OF THE INVENTION

A method which has been used to increase the capacity of cellular communication systems is the concept of hierarchical cells wherein a macro-cell layer is underlayed by a layer of typically smaller cells having coverage areas within the coverage area of the macro-cell. In this way, smaller cells, known as micro-cells, pico-cells, or femto-cells, are located within larger macro-cells. The micro-cells, pico-cells, and femto-cells have much smaller coverage thereby allowing a much closer reuse of resources. Frequently, the macro-cells are used to provide coverage over a large area, and micro-cells and pico-cells are used to provide additional capacity in, e.g., densely populated areas and hotspots. Furthermore, pico-cells and femto-cells can also be used to provide coverage in specific locations such as within a residential home or office.

In order to efficiently exploit this additional resource, it is important that handover and cell-selection performance between the macro-cell layer and the underlying layer is optimized.

The current trend is towards introducing a large number of pico-cells and femto-cells to 3G systems. For example, it is envisaged that residential access points may be deployed having only a target coverage area of a single residential dwelling or house. The use of residential cells may not only provide increased capacity but may also facilitate service and subscription differentiation. For example, a subscriber may pay a substantially lower cost when at home using his dedicated residential access point than when using the cellular communication system remotely. A widespread introduction of residential access points would result in a very large number of small underlay cells within a single macro-cell.

However, underlaying a macrolayer of a 3G network with a pico-cell or femto-cell layer creates several issues that must be addressed. In particular, it makes efficient handover and cell-selection techniques even more critical. In particular, it is desirable that handover and cell selection are efficient and simple, and seamless mobility for the mobile station between the layers is preferably allowed. Furthermore, it is desired that the interference from the underlay layer to the macrolayer is minimized.

Specifically, as cellular operators increasingly deploy femto-cells at subscribers' premises to improve indoor coverage and offer over-the-top services, they gradually build up a femto underlay access network that shares the spectrum with the operator's macro-cellular network and which therefore introduces additional interference onto the macro-cellular network.

In order to reduce the interference to the macro-layer it has been proposed to selectively switch the femto base stations on and off. For example, it has been proposed that a user equipment may control whether a femto base station is switched on or off. The 3rd Generation Partnership Project (3GPP) standards contribution R3-080658 submitted by Mitsubishi Electric at the 3GPP TSG RAN WG3 Meeting #59bis in Shenzhen, China, 31st Mar.-3rd Apr., 2008, discussed some possible approaches to selectively switching a base station on and off.

However, the described approaches tend to be suboptimal and specifically tend to require that the operation is controlled by the user equipment or tend to result in relatively indiscriminate switching on and off of a base station. For example, the described approaches tend to require additional user equipment functionality to support the selective switching thereby resulting in additional complexity and resource usage for the user equipment. These approaches therefore tend to rely on new user equipment being developed and deployed in order to support the operation.

Also the described approaches tend to result in a relatively inefficient and inflexible operation wherein, e.g., a femto base station is simply switched on when user equipment is in the vicinity of the base station. However, this is likely to result in the femto base station potentially being switched on relatively frequently thereby resulting in a relatively high power consumption and interference to the macro-layer.

Hence, an improved cellular communication system would be advantageous, and in particular a system allowing reduced interference, facilitated operation, reduced requirements for user equipment, reduced power consumption, facilitated implementation, or improved performance would be advantageous.

### BRIEF SUMMARY

A cellular communication system comprises a network supporting user equipment over an air interface, the network having a hierarchical cell arrangement with overlay cells and underlay cells. An underlay base station is associated with a subset of registered user equipment. An activation server switches the underlay base station between an inactive mode and an active mode in response to detecting that registered user equipment meets a location criterion. The underlay base station only supports user equipment when in the active mode, e.g., it may only transmit a pilot signal in this mode. Interference and power consumption may be substantially reduced by sending the base station into the inactive mode thereby resulting in increased capacity of the cellular communication system as a whole.

### BRIEF DESCRIPTION OF THE SEVERAL VIEWS OF THE DRAWINGS

Embodiments of the invention will be described, by way of example only, with reference to the drawings, in which:

FIG. 1 illustrates some elements of a cellular communication system in accordance with some embodiments of the invention;

FIG. 2 illustrates some elements of an underlay base station for a cellular communication system in accordance with some embodiments of the invention;

FIG. 3 illustrates some elements of an activation server for a cellular communication system in accordance with some embodiments of the invention; and

FIG. 4 illustrates an example of a method of operation for a cellular communication system in accordance with some embodiments of the invention.

### DETAILED DESCRIPTION OF SOME EMBODIMENTS OF THE INVENTION

The following description focuses on embodiments of the invention applicable to a 3rd Generation Partnership Project cellular communication system comprising a large number of femto-cells. The cellular communication system may specifically be a Universal Mobile Telecommunication System. However, it will be appreciated that the invention is not limited to this application but may be applied to many other cellular communication systems and cell configurations.

Many operators of cellular communication systems plan to deploy femto-cells at subscribers' premises to improve indoor wireless coverage, to utilize the subscribers' broadband access services that are typically offered by other operators, and to provide Over The Top services (e.g., Voice over Internet Protocol, Short Messaging Services, etc.). A femto-cell is typically an indoor low power cellular base station with a relatively small footprint that resides within the subscriber's premises. The femto-cell is typically connected either directly, or via a subscriber's Home Gateway, to the Internet through the subscriber's Broadband Service Provider DSL or Cable Modem. A femto-cell may typically support about half a dozen mobile devices and may typically cover a whole premise or a part of it. The femto-cells may allow the operator to provide differentiated and additional services and may for example allow the cellular operator to more effectively compete with broadband service providers (such as Internet Service Providers (ISPs)).

The femto-cells share the cellular network spectrum with other femto-cells as well as with the overlay cells, such as micro-cells and macro-cells. For example, for Code Division Multiple Access systems the cells may communicate using the same frequency bandwidth. Thus, the femto-cells introduce interference to the system which may reduce the overall capacity of the system, and therefore the overall infrastructure requires a more efficient management system to deal with additional complexities including new radio resource management algorithms and heuristics operating within and across the macro-cellular network and its femto underlay subsystem to contain the interference.

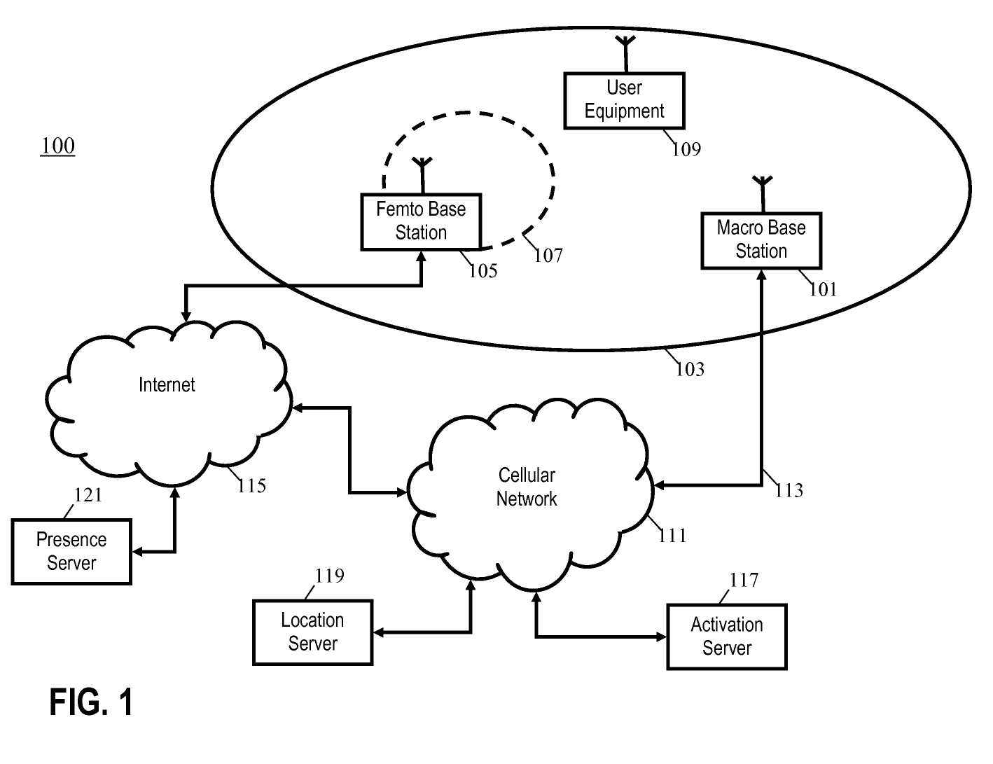

FIG. 1 illustrates some elements of a cellular communication system 100 in accordance with some embodiments of the invention. The cellular communication system 100 employs a hierarchical cell arrangement wherein at least one layer of overlay cells is supported in various locations by underlay cells. The overlay cells may specifically be macro-cells, and the underlay cells may be micro-cells, pico-cells, or femto-cells (or a combination thereof).

FIG. 1 specifically illustrates a macro base station 101 which supports a macro-cell 103. Within the macro-cell 103 a femto base station 105 supports a femto-cell 107. User equipment 109 may move within the system and may for example handover between the macro-cell 103 and the femto-cell 107. The user equipment 109 may be any communication entity capable of communicating with a base station (or access point) over an air interface including, e.g., a mobile phone, a mobile terminal, a mobile communication unit, a remote station, a subscriber unit, and a 3G User Equipment.

It will be appreciated that FIG. 1 for brevity and clarity only shows a single femto base station 105, a single macro base station 101, and a single remote station 109, whereas a cellular communication system 100 will typically comprise a large number of these. It will also be appreciated that although FIG. 1 illustrates an underlay base station in the form of the femto base station 105, the underlay base station may in other examples be a pico or micro base station.

In the system 100, a network supports the user equipment 109. The network may be considered to include all functionality outside the user equipment 109 which is involved in or which directly or indirectly supports communications over the air interface including associated functions such as billing, operations, and management. Thus, the network may be considered to denote any functionality not part of the user equipment section and may include the base stations, backhaul networks, management functionality, etc. The term network may specifically denote the entire infrastructure section of the communication system 100 of FIG. 1.

The system 100 of FIG. 1 comprises a cellular network 111 (which is part of the network) which is arranged to provide all the functions required or desired for supporting the base stations and user equipment of the system 100. The cellular network 111 specifically represents all aspects of the fixed segment of the 3GPP communication system including other base stations, Radio Network Controllers, Mobile Switching Centres, Gateways, and Serving Network General Packet Radio Service Nodes (SGSNs and GGSNs), Home Location Registers, etc., as will be well known to the person skilled in the art.

In the example, the macro base station 101 is coupled to the cellular network 111 via a suitable backhaul connection 113. For example, the macro base station 101 may be coupled to a supporting RNC of the cellular network 111 via a T1 or microwave backhaul connection.

In some embodiments the femto base station 105 may also be directly coupled to the cellular network 111. However, in the specific embodiment, the femto base station 105 is coupled to an intermediate network which is further coupled to the cellular network 111. Thus, the femto base station 105 may provide services to the user equipment 109 from both the intermediate network as well as from the cellular network 111. The intermediate network may also be considered part of the network of the system 100 of FIG. 1.

In the specific example, the intermediate network is the Internet 115. For example, the femto base station 105 may be directly coupled to the Internet or may be coupled to the Internet 115 via the subscriber's home gateway that is connected to the Internet. The connection to the Internet 115 may for example be via a standard coupling such as a DSL (Digital Subscriber Line) or cable modem. However, the home gateway and the femto base station 105 are owned and operated by the cellular operator whereas the Internet connection equipment (the modem) may or may not be owned and operated by the cellular operator. For example, the connection to the Internet 115 may be a standard broadband connection provided by a suitable ISP.

As the operator and subscribers deploy femto-cells, an underlay femto-cell network is gradually built up that supports the user equipment but which also introduces additional interference to the macro-cellular network (and also to other lower layer cells such as micro-cells, pico-cells, and other femto-cells) It is thus highly important to manage and mitigate for this increased interference. In the system 100 of FIG. 1, the individual femto base station 105 is controlled from the cellular network 111 such that it can operate in at least two different modes. In an active mode, the femto base station 105 operates to fully support the user equipment 109 allowed to use the femto base station 105. However, the system 100 of FIG. 1 may also force the femto base station 105 into an inactive mode wherein the femto base station 105 does not support any user equipment but at the same time reduces or eliminates any introduced interference. For example, in the active mode, the femto base station 105 may transmit a pilot signal which allows the user equipment 109 to detect the femto base station 105 and thus to handover or attach to this. However, in the inactive mode the femto base station 105 may not transmit any pilot signal thereby reducing interference and power consumption.

In the system 100, the network comprises functionality for tracking and monitoring locations of a specific set of registered user equipment for each femto base station and for controlling the operational mode of the femto base stations based on the specific locations (e.g., physical locations or network locations) of the specific set of registered user equipment. Furthermore, the state may also be controlled in dependence on the operational state or activity of this user equipment, such as specifically in dependence on a network presence indication for the user equipment.

Specifically, the system 100 of FIG. 1 comprises an activation server 117 which is arranged to transmit messages to the femto base station 105 to control whether it operates in the active mode or in the inactive mode. As a specific example, the activation server 117 may control the femto base station 105 to operate in the active mode if a registered user equipment is within or sufficiently close to the femto-cell 107 and to operate in the inactive mode if all of the registered user equipment is known to be sufficiently far away from the femto-cell 107.

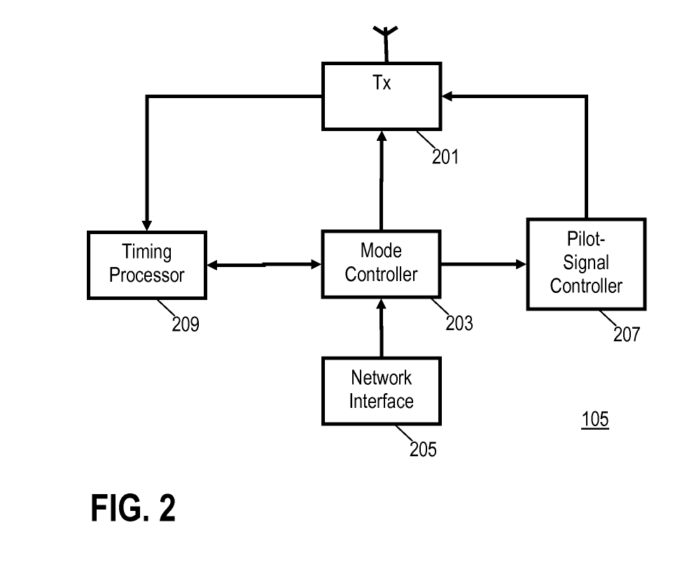

FIG. 2 illustrates an example of elements of the femto base station 105 of FIG. 1. The femto base station 105 comprises a transceiver 201 which is capable of communicating with the user equipment 109 (and possibly with the macro base station 101) over the air interface of the cellular communication system. Specifically the transceiver 201 can communicate with the user equipment 109 (and possibly the macro base station 101) in accordance with the 3GPP Technical Standards.

The transceiver 201 is coupled to a mode controller 203 which is arranged to control the mode of operation of the femto base station 105. Thus, the mode controller 203 can switch the femto base station 105 between the active mode and the inactive mode. The mode controller 203 is coupled to a network interface 205 which provides the required interfacing to the cellular network 111. The network interface 205 can specifically exchange messages with the activation server 117 and forward these messages to the mode controller 203. The mode controller 203 controls the mode of operation of the femto base station 105 in response to control messages received from the activation server 117. Specifically, if an activation message is received from the activation server 117, the femto base station 105 is entered into the active mode of operation (if it is not already operating in this mode). If a deactivation message is received from the activation server 117, the femto base station 105 is entered into the inactive mode of operation (if it is not already operating in this mode).

When the femto base station 105 operates in the active mode it can support user equipment in the femto-cell 107. Specifically, user equipment can handover or attach to the femto base station 105, and communication sessions can be set up and maintained. However, when the femto base station 105 operates in the inactive mode it cannot support user equipment in the femto-cell 107. Specifically, user equipment cannot handover or attach to the femto base station 105. In some embodiments, ongoing communications may furthermore be terminated when the femto base station 105 switches to the inactive mode, whereas in other embodiments ongoing communications may be supported.

In the example, the femto base station 105 is specifically arranged to transmit a pilot signal when in the active mode but not when in the inactive mode. Thus, the femto base station 105 comprises a pilot-signal controller 207 which is coupled to the transceiver 201 and to the mode controller 203. The pilot-signal controller 207 is capable of generating a pilot signal and of controlling the transceiver 201 to transmit this pilot signal when in the active mode but not when in the inactive mode. The pilot signal may for example be a broadcast channel such as a Broadcast Control Channel.

The mode controller 203 thus controls the pilot-signal controller 207 such that the pilot signal is only transmitted when the femto base station 105 is in the active mode. When the femto base station 105 is switched into the inactive mode by the mode controller 203 the transmission of the pilot signal is switched off. Likewise, when the femto base station 105 is switched into the active mode from the inactive mode by the mode controller 203 the transmission of the pilot signal is switched on.

In cellular communication systems, such as 3GPP systems, the pilot signals transmitted by the base stations are used by the user equipment to detect the presence of the base stations. Accordingly, in the absence of a pilot signal, the user equipment will not be able to detect the femto base station 105 and thus will not be able to attach or handover to the femto base station 105. Accordingly, when in the inactive mode, the absence of any pilot signal being transmitted will prevent user equipment from being supported by the femto base station 105.

The transmission of pilot signals introduces interference to the system, and, for example, in many scenarios wherein a large number of femto-cells are deployed in a relatively limited geographic area, the introduced interference from femto-cells may be substantial. Accordingly, by selectively switching off the transmission of pilot signals, a substantial interference reduction can be achieved.

Furthermore, the power consumption of the femto base station 105 may be substantially reduced when in the inactive mode. In many embodiments, the power consumption will be heavily dependent on the transmissions made by the femto base station 105, and therefore the cessation of the transmission of the pilot signal may substantially reduce the power consumed. In addition, the femto base station 105 may power down other circuitry which is not needed in the inactive state where no user equipment is supported. Indeed the femto base station 105 may power down almost all functionality not needed for controlling the operational mode of the femto base station 105. This may provide even further power consumption reduction.

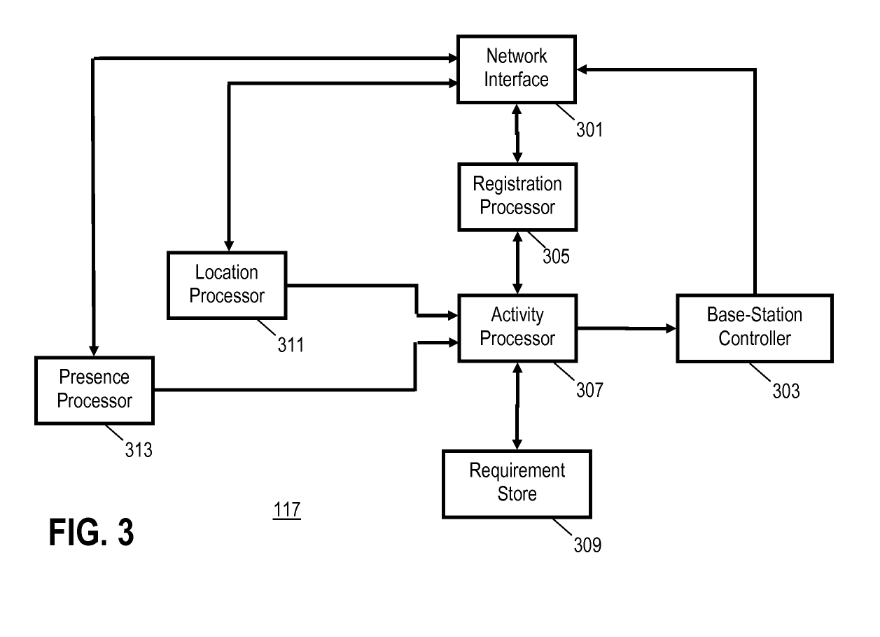

FIG. 3 illustrates an example of elements of the activation server 117 of FIG. 1. The activation server 117 comprises a network interface 301 which interfaces the activation server 117 to the cellular network 111.

The network interface 301 is coupled to a base-station controller 303 which is operable to transmit control messages to femto base stations in order to control their mode of operation. Specifically, the base-station controller 303 can generate an activation message for a base station that will cause this base station to operate in the active mode. Also, the base-station controller 303 can generate a deactivation message for a base station that will cause this base station to operate in the inactive mode. The base-station controller 303 can transmit these messages to the appropriate base station via the network interface 301.

The activation server 117 furthermore comprises a registration processor 305 which is coupled to the network interface 301. For each of the femto base stations controlled by the activation server 117, the registration processor 305 can determine a subset of the registered user equipment that is registered for the base station.

Thus, the femto base stations have a set of registered user equipment that is specifically registered for the base station at the activation server 117. Typically, this number is relatively low, and indeed the subset may in some embodiments comprise only one user equipment. However, for most base stations the number of user equipment in the subset will typically be around perhaps five to fifteen. In the system, the decision of whether to operate the base station in the active or in the inactive mode is specifically based on characteristics of the registered user equipment rather than being based on user equipment per se. Thus, the set of user equipment that is registered at the activation server 117 for a given femto base station 105 determines the set of registered user equipment that is considered when deciding the operational mode of the base station 105. Specifically, no other user equipment may be taken into account when the activation server 117 determines the active state to apply to the femto base station 105. This approach may allow an improved and targeted adaptation of the underlay operation to specific user equipment.

In some embodiments, a specific femto base station may only support user equipment that is included in the set of user equipment registered at the activation server 117. For example, a femto-cell may be deployed in a subscriber's residence in order to provide an improved, differentiated, and, e.g., cheaper service to the subscriber in his home environment. Accordingly, all user equipment owned by the subscriber may be registered both with the base station 105 and with the activation server 117. However, other user equipment, such as user equipment of visiting subscribers, may be prevented from using the femto-cell. Such an approach may allow an operator of a cellular system to provide differentiated services, and in particular may allow the operator to compete with other communication providers, such as ISPs, in the home environment while still being able to maintain revenue for other subscribers.

In some embodiments, the set of user equipment registered at the activation server 117 may be different from the set of registered user equipment supported by the femto base station 105. For example, all user equipment owned by a subscriber may be registered for support by the femto base station 105 whereas only a smaller subset is registered at the activation server 117. This may allow the operational mode of the base station 105 to be targeted to a specific subset of user equipment owned by the subscriber.

For example, a subscriber may own a mobile phone, a laptop computer, and a desktop computer. All of these devices may be authorised for use with the femto base station 105. However, the desktop computer may also be supported by a direct wired connection to the Internet 115 and may therefore always be located within the femto-cell 107 without needing access to the femto base station 105 except for in extraordinary circumstances (e.g., if the wired connection fails). Accordingly, it may be disadvantageous to consider the desktop computer when determining whether the femto base station 105 should operate in the active or inactive mode (indeed such a scenario may result in the femto base station 105 always being in the active mode thereby resulting in increased interference and power consumption). Accordingly, only the mobile phone and laptop computer may be registered at the activation server 117 such that the selection of the appropriate operational mode is based only on this user equipment.

It will be appreciated that any method or algorithm for registering user equipment at the activation server 117 may be used without detracting from the invention.

For example, the cellular operator may manually enter the identity of the user equipment which belongs to a subscriber for which the femto base station 105 is deployed. As another example, the process may be automated with the use of the femto base station 105. E.g., the femto base station 105 may be entered into a registration mode followed by all of the user equipment that the subscriber wants registered accessing the femto base station 105. The femto base station 105 may then combine the identities of this user equipment into a message that is communicated to the activation server 117. The message is then fed to the registration processor 305 which stores the identities of the user equipment.

The system 100 of FIG. 1 also comprises a location server 119 which is arranged to determine location indications for user equipment. The location server 119 can specifically contain information regarding the point of attachment of user equipment in the network. The location indications are transmitted to the activation server 117 which uses them to determine the operational state of an individual femto base station. Accordingly, the activation server 117 comprises a location processor 311 which is coupled to the network interface 301 and which is arranged to receive the location indications transmitted from the location server 119.

It will be appreciated that in other embodiments, the location server 119 may, e.g., be part of the activation server 117.

It will be appreciated that in different embodiments and scenarios different location indications may be used. For example, in some embodiments user equipment may comprise GPS functionality which allows the user equipment to accurately determine its precise location. The user equipment may furthermore be arranged to regularly transmit this information to the cellular network 111 and specifically to the location server 119. The GPS location indications may then be forwarded to the activation server 117. As another example, relatively accurate location estimates may be generated by use of triangulation techniques as will be well known to the person skilled in the art. Such location estimates may be generated by the user equipment or by the network.

In other embodiments coarser location indications may be used. For example, the location of user equipment may simply be determined by the current cell serving the user equipment. Thus, the granularity of the location indication may simply be at a cell level.

It will also be appreciated that the location indications need not be indications of a strict geographical location but may alternatively or additionally represent a network location, such as, e.g., indicated by a point of attachment or a “care of” address currently allocated to the user equipment.

It will be appreciated that in different embodiments the communication of location indications from the location server 119 to the activation server 117 may be instigated by the location server 119 or may be instigated by the activation server 117 requesting location information. In some embodiments, the location information may for example be transmitted at regular intervals or may, e.g., be transmitted when a given event occurs, such as for example when a new location estimate is generated or received from the user equipment.

The activation server 117 comprises an activity processor 307 which is coupled to the registration processor 305, to the base-station controller 303, and to the location processor 311. The activity processor 307 is furthermore coupled to a requirement store 309 which stores requirements that must be met in order for a femto base station to be switched between the active and the inactive modes of operation. The requirements may be general requirements or alternatively or additionally may be specific requirements for the individual femto base station.

Specifically, at frequent intervals, the activity processor 307 evaluates whether the activity mode of operation of the femto base station 105 should be changed. The activity processor 307 first retrieves the set of registered user equipment from the registration processor 305. It then requests a location indication for each registered user equipment from the location processor 311 and retrieves the requirements stored for the femto base station 105 from the requirement store 309.

The requirements specifically comprise a criterion that must be met for the location indications of the registered user equipment. Specifically, if the femto base station 105 is currently in the inactive mode and if registered user equipment has a location indication that meets the given criterion for waking up the femto base station 105, the activity processor 307 proceeds to instruct the base-station controller 303 to transmit an activity message to the femto base station 105 causing it to enter the active mode. Conversely, if the femto base station 105 is currently in the active mode and if registered user equipment has a location indication that meets the given criterion for deactivating the femto base station 105, the activity processor 307 proceeds to instruct the base-station controller 303 to transmit a deactivation message to the femto base station 105 causing it to enter the inactive mode.

It will be appreciated that in different embodiments different criteria can be used for switching the femto base station 105 between the active and inactive modes. It will also be appreciated that in some embodiments the requirements for switching from the active to the inactive mode is complementary to the requirements for switching from the inactive mode to the active mode. In other embodiments, non-symmetric requirements may be used for switching between the two modes.

In the specific example, the decision to switch the femto base station 105 from the inactive mode to the active mode is reached if the location indication of registered user equipment is indicative of the user equipment being sufficiently close to the femto-cell 107. However, the decision to switch the femto base station 105 from the active mode to the inactive mode is reached if the location indication of all registered user equipment is indicative of the user equipment being sufficiently remote from the femto-cell 107. Thus, in the example the switch from the inactive to the active mode is based on a single user equipment meeting a criterion whereas the switch from the active to the inactive mode is based on all user equipment meeting a criterion.

As a specific example, the activity processor 307 may determine that the base station 105 should switch from the inactive mode to the active mode if one registered user equipment has a location indication that indicates that the user equipment is within a specific area that includes the femto-cell 107. Furthermore, in the example, the activity processor 307 determines that the base station 105 should switch from the active mode to the inactive mode if all registered user equipment has a location indication which indicates that the user equipment is outside a specific area that includes the femto-cell 107.

The area used to determine whether to switch operational mode may in some embodiments specifically correspond to a coverage area of a set of cells.

The set of cells may in some examples comprise only a single cell. For example, in some embodiments, the set of cells may simply comprise a micro-cell or macro-cell that overlays the femto-cell 107. In the specific example of FIG. 1, the activity processor 307 may apply the requirement that the femto base station 105 is switched from the active to the inactive mode if it is determined that all of the user equipment registered for the femto base station 105 are outside the macro-cell 103 overlaying the femto-cell 107. Similarly, the activity processor 307 may apply the requirement that the femto base station 105 is switched from the inactive mode to the active mode if any user equipment registered for the femto base station 105 is within the macro-cell 103. The determination of whether user equipment is outside or inside the macro-cell 103 may simply be determined on the basis of whether the macro-cell 103 supports the user equipment or not (whether in active or in idle mode). Thus, the activation server 117 can switch on the pilot signal transmission of the femto base station 105 each time registered user equipment re-enters the macro-cell 103 (or macro-cells) covering the femto-cell 107 and may switch off the pilot signal transmission when the last registered user equipment leaves the macro-cell 103.

In some examples, the set of cells comprise one or more underlay cells at the same layer as the femto-cell 107. Thus, in such an example, the set of cells may specify a number of neighbouring femto-cells and may specify that the femto base station 105 is switched from the active to the inactive mode if all user equipment is outside the area formed by the set of neighbouring femto-cells and that the base station is switched from the inactive mode to the active mode if any user equipment moved within the area formed by the neighbouring femto-cells. Hence, if none of the registered user equipment is served by any of the femto-cells of the set (or by the femto-cell 107 itself), the activation server 117 may ensure that the base station 105 operates in the inactive mode, and otherwise it may ensure that base station 105 operates in the active mode. This approach may be particularly advantageous in scenarios where a contiguous coverage of an area is provided by a plurality of femto-cells.

In some embodiments, the activation server 117 can be arranged to control the femto base station 105 to operate in the active mode if a valid location indication is not available for some registered user equipment.

For example, when the activity processor 307 requests location indications from the location processor 311, it may evaluate if a location indication is indeed available for all of the registered user equipment. If so, the activation server 117 has the required information to determine whether the base station 105 should operate in the active or in the inactive mode. However, if no valid location indication is provided for some user equipment, it cannot be determined whether this user equipment is likely to require the support of the femto base station 105. For example, the lack of a valid location indication for user equipment may be due to the fact that this user equipment is currently switched off, and that accordingly the network has no information of where the user equipment is. In this case, the activation server 117 may ensure that the femto base station 105 is operated in the active mode such that it can support the user equipment should this be switched on within the femto-cell.

The activation server 117 can control the femto base station 105 to operate in the active mode by transmitting an activation message to the femto base station 105 whenever it is detected that a valid location indication is missing for at least some registered user equipment. If the femto base station 105 is already operating in the active mode, the activation server 117 may simply ensure this operation by suppressing any deactivation messages for the femto base station 105.

Thus, the described system may provide an improved performance and operation of a cellular system supporting underlay cells. In particular, the interference caused by a large number of underlay base stations supporting such underlay cells may be substantially reduced while at the same time providing virtually the same level of support for user equipment. Furthermore, the benefits are achieved without requiring any modifications or alterations to the user equipment thereby allowing the benefits to be provided for an already deployed population of user equipment. The system can specifically harmonize the use of spectrum on the femto underlay layer and the macro-layer by utilizing information and processing in the network.

Also, the operation of the femto base station 105 can be adapted and targeted to the individual requirements and preferences for individual user equipment. For example, an increased interference reduction can be achieved by ensuring that the femto base stations are only activated when required for support of specific user equipment.

It will be appreciated that in some embodiments the control of the femto base station 105 by the activation server 117 may furthermore be enhanced by an additional localised control of the mode of operation. For example, the femto base station 105 may switch from the inactive mode to the active mode in response to a local action or conditions. For example, it may be possible for a user to manually wake up the femto base station 105, e.g., by simply pressing a suitable button on the femto base station 105. As another example, the femto base station 105 may comprise a dedicated receiver for receiving a specific wake-up signal from user equipment. This dedicated receiver may be operated in the inactive mode such that if user equipment transmits a dedicated wake-up signal (e.g., in response to the user pressing a dedicated button on the user equipment 109), this will be detected by the femto base station 105 which accordingly switches to the active mode.

Such approaches may allow a user to manually wake up the femto base station 105 in situations wherein it is required to support user equipment not registered at the activation server 117. For example, if the desktop computer of the previous example requires support from the femto base station 105 at a time where all registered user equipment is outside the macro-cell 103, the user may manually wake up the femto base station 105.

In some embodiments, the femto base station 105 is arranged to autonomously enter the active mode from the inactive mode at intermittent intervals. For example, the femto base station 105 can comprise a timing processor 209 which detects when the femto base station 105 enters the inactive mode. It may then proceed to generate an activation signal at regular intervals (say every 5-10 minutes) and feed this to the mode controller 203. In response, the mode controller 203 switches the femto base station 105 to the active mode and specifically controls the pilot-signal controller 207 to transmit a pilot signal. Accordingly, any user equipment not registered at the activation server 117 (but authorised to use the femto base station 105) can then detect the presence of the femto base station 105 and access it. For example, the desktop computer may automatically determine that the wired network connection is not currently working and may proceed to search for the femto base station 105. When this is detected it may then proceed to attach to the femto base station 105. Thus, this approach may allow user equipment that is not registered at the activation server 117 to still be supported despite the femto base station 105 predominantly being in the inactive mode.

In these examples, the mode controller 203 may automatically return the femto base station 105 to the inactive mode after a suitable time interval in case no user equipment has accessed the femto base station 105. The time interval may be determined by an event occurring or may, e.g., be a fixed time interval (say one minute). If user equipment authorised to be supported by the femto base station 105 has accessed the femto base station 105 during the time interval, the femto base station 105 remains in the active mode until all such user equipment has ceased this access (and all registered user equipment meets the requirements for the inactive mode). A user equipment may for example access the femto base station 105 by handing over an active communication or by attaching to the femto base station 105 as an idle mode user equipment.

In some embodiments, the decision of which mode to operate the femto base station 105 in is further dependent on presence indications for the registered user equipment.

In the specific example, the system 100 comprises a presence server 121 which is coupled to the Internet 115. The presence server 121 can operate a presence service which indicates whether specific user equipment is currently available in the network (e.g., for the specific service). Thus, the presence server 121 can provide information regarding the active presence of user equipment in the network. It will be appreciated that any suitable method or algorithm for executing a presence service may be used without detracting from the invention.

In the example, the activation server 117 furthermore comprises a presence processor 313 that is coupled to the network interface 301 and to the activity processor 307. The presence processor 313 can receive presence indications for the set of registered user equipment from the presence server 121. It may then feed these presence indications to the activity processor 307 which uses them when determining whether to operate the femto base station 105 in the active or in the inactive mode.

For example, if there is no valid location indication for registered user equipment, this may be due to the user equipment being attached to the network at a location that does not result in a location indication being generated or communicated to the location server 119. Alternatively, it may be due to the user equipment being switched off. In this case, the activity processor 307 may proceed to put the femto base station 105 into the inactive mode if the location indication is invalid, but the presence indication is indicative of the user equipment currently being present somewhere in the network as this will be an indication that the user equipment is indeed switched off and away from the femto-cell 107 (as a valid location indication would otherwise be provided by the macro base station 101). If the presence indication is indicative of the user equipment not being present, it is more likely that the user equipment is switched off, and accordingly the femto base station 105 is kept in the active mode in case the user equipment is switched on within the femto-cell 107.

In some embodiments, the presence server 121 may automatically generate presence update messages, e.g., at regular intervals or when specific events happen, and transmit these to the activation server 117. However, alternatively or additionally the activation server can be arranged to repeatedly request presence indications for the set of registered user equipment from the presence server 121. For example, whenever the activity processor 307 requests location indications from the location processor 311 it may also request presence indications from the presence processor 313. In response, the presence processor 313 may transmit a request message to the presence server 121 indicating the identity of the user equipment registered for the base station.

In some embodiments, the location indication for user equipment may be determined based on a point of attachment for the user equipment. For example, the femto base stations may be coupled to the cellular network 111 via the Internet 115 using the Internet Protocol (IP). The Internet 115 may specifically include subnets that support IP mobility, and thus the Internet 115 may be considered a mobile IP network.

In the example, each femto base station may be a separate point of attachment to the Internet 115 and thus also to the cellular network 111. In this case, the current point of attachment to the Internet 115 for a given user equipment may be used to determine the location indication (or may be used directly as the location indication). For example, the location indication for a given user equipment may correspond to an identification of the subnet to which the point of attachment that is currently used by the user equipment belongs. This information may be provided to the activity processor 307 which may compare it to an identification of the subnet known to support an area surrounding the femto-cell 107. If the subnets match, it is likely that the user equipment is close to the femto-cell 107 and accordingly the femto base station 105 is kept in the active state. However, if they do not match the femto base station 105 may be entered into the inactive state (provided the requirements are met for all other user equipment).

Specifically, for a mobile IP network, roaming user equipment may change the current point of attachment to the IP network (e.g., to the Internet 115 or a subnet thereof). When user equipment roams in such a network it is dynamically allocated a Care-of-Address (CoA). This CoA is fed to a Home Agent (HA) which uses it to bind a Home Address (HoA) for the user equipment to the CoA. Accordingly, data packets addressed to the HoA of the user equipment reach the HA which proceeds to tunnel them to the current CoA for the user equipment. In such systems, the CoA typically provides an identification of the subnetwork for the current point of attachment (typically this is indicated by a prefix of the IP address). Thus, in some examples the presence processor 313 may transmit a request to the HA of the user equipment which in return may transmit the current CoA for the user equipment to the presence processor 313. This can then be fed to the activity processor 307 which can compare it to the subnet address of the femto base station 105. If they match, it is likely that the user equipment is close to the femto-cell, and therefore the femto base station 105 is maintained in the active state, and otherwise it is returned to the inactive state.

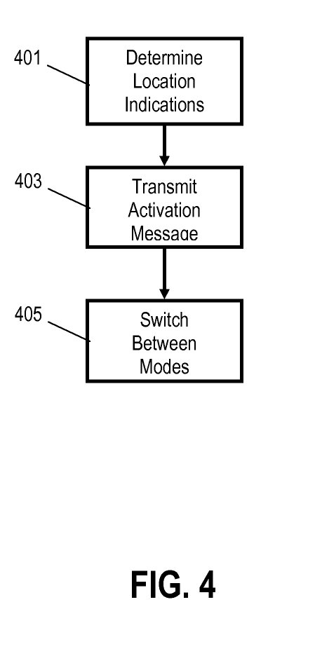

FIG. 4 illustrates an example of a method of operation for a cellular communication system in accordance with some embodiments of the invention.

The cellular communication system comprises a network supporting user equipment over a cellular air interface that has a hierarchical cell arrangement with a plurality of overlay cells and underlay cells. The cellular communication system comprises at least one underlay base station for supporting an underlay cell of the cellular communication system. The underlay base station is associated with a subset of registered user equipment registered for the underlay base station.

The method initiates in step 401 wherein location indications are determined for user equipment.

Step 401 is followed by step 403 wherein an activation server transmits an activation (or de-activation) message to the underlay base station in response to a detection that a location indication for a first user equipment meets a first criterion, and that the first user equipment is in the subset of registered user equipment.

Step 403 is followed by step 405 wherein the underlay base station switches from an inactive mode to an active mode in response to receiving the activation message (or from an active mode to an inactive mode in response to a de-activation method). The underlay base station is arranged to support user equipment of the first underlay cell when in the active mode and to not support user equipment of the first underlay cell when in the inactive mode.

It will be appreciated that the above description for clarity has described embodiments of the invention with reference to different functional units and processors. However, it will be apparent that any suitable distribution of functionality between different functional units or processors may be used without detracting from the invention. For example, functionality illustrated to be performed by separate processors or controllers may be performed by the same processor or controllers. Hence, references to specific functional units are only to be seen as references to suitable means for providing the described functionality rather than indicative of a strict logical or physical structure or organization.

The invention can be implemented in any suitable form including hardware, software, firmware, or any combination of these. The invention may optionally be implemented at least partly as computer software running on one or more data processors or digital signal processors. The elements and components of an embodiment of the invention may be physically, functionally, and logically implemented in any suitable way. Indeed the functionality may be implemented in a single unit, in a plurality of units, or as part of other functional units. As such, the invention may be implemented in a single unit or may be physically and functionally distributed between different units and processors.

Although the present invention has been described in connection with some embodiments, it is not intended to be limited to the specific form set forth herein. Rather, the scope of the present invention is limited only by the accompanying claims. Additionally, although a feature may appear to be described in connection with particular embodiments, one skilled in the art would recognize that various features of the described embodiments may be combined in accordance with the invention. In the claims, the term comprising does not exclude the presence of other elements or steps.

Furthermore, although individually listed, a plurality of means, elements or method steps may be implemented by, e.g., a single unit or processor. Additionally, although individual features may be included in different claims, these may possibly be advantageously combined, and the inclusion in different claims does not imply that a combination of features is not feasible or advantageous. Also the inclusion of a feature in one category of claims does not imply a limitation to this category but rather indicates that the feature is equally applicable to other claim categories as appropriate. Furthermore, the order of features in the claims does not imply any specific order in which the features must be worked, and in particular the order of individual steps in a method claim does not imply that the steps must be performed in this order. Rather, the steps may be performed in any suitable order.

We claim:

1. A cellular communication system comprising a network supporting user equipment over a cellular air interface having a hierarchical cell arrangement with a plurality of overlay cells and underlay cells, the cellular communication system comprising:
an underlay base station (105) for supporting a first underlay cell of the plurality of underlay cells, the underlay base station (105) being associated with a set of user equipment registered for the underlay base station (105);
a location server (119) for determining location indications for user equipment; and
an activation server (117) of the network arranged to receive location indications from the location server (119) and to transmit an activation message to the underlay base station (105) in response to a detection that a location indication for a first user equipment meets a first criterion and that the first user equipment is in the set of registered user equipment;
wherein the underlay base station (105) is arranged to switch from an inactive mode to an active mode in response to receiving the activation message; and
wherein the underlay base station (105) is arranged to support user equipment of the underlay cell when in the active mode and to not support user equipment of the underlay cell when in the inactive mode.

2. The cellular communication system of claim 1 wherein the underlay base station (105) is arranged to support only user equipment belonging to the set of registered user equipment.

3. The cellular communication system of claim 1 wherein the activation server (117) is arranged to transmit a deactivation message to the underlay base station (105) in response to a detection that location indications for all user equipment of the set of registered user equipment meet a second criterion; and
wherein the underlay base station (105) is arranged to switch from the active mode to the inactive mode in response to receiving the deactivation message.

4. The cellular communication system of claim 3 wherein the second criterion comprises a requirement that a location indication for each user equipment of the set of registered user equipment is indicative of the user equipment being outside an area comprising the first underlay cell.

5. The cellular communication system of claim 4 wherein the area corresponds to a coverage area of a set of cells.

6. The cellular communication system of claim 5 wherein the set of cells comprises at least one overlay cell overlaying the first underlay cell.

7. The cellular communication system of claim 5 wherein the set of cells comprises at least one neighbour underlay cell for the first underlay cell.

8. The cellular communication system of claim 1 wherein the activation server (117) is arranged to control the underlay base station (105) to operate in the active mode if a valid location indication is not available for at least one user equipment of the set of registered user equipment.

9. The cellular communication system of claim 1 wherein the location server (117) is arranged to determine a location indication for a first user equipment of the set of registered user equipment in response to a point of attachment for the first user equipment.

10. The cellular communication system of claim 9 wherein the point of attachment is a point of attachment for a mobile Internet Protocol network supporting user equipment of the cellular communication system.

11. The cellular communication system of claim 10 wherein a plurality of underlay base stations are coupled to a cellular communication network of the network via the mobile Internet Protocol network.

13. The cellular communication system of claim 1 wherein the location server (119) is arranged to determine a location indication for a first user equipment of the set of registered user equipment in response to a care of network address for the first user equipment.

14. The cellular communication system of claim 1 wherein the underlay base station (105) is arranged to autonomously switch to the active mode from the inactive mode at intermittent intervals and to autonomously return to the inactive mode after a time interval if no user equipment has accessed the underlay base station within the time interval.

15. The cellular communication system of claim 1 wherein the activation server (117) is arranged to receive presence indications for the set of registered users equipment from a presence service and to control the underlay base station (105) to operate in one of the active mode and the inactive mode in response to the presence indications.

16. The cellular communication system of claim 15 wherein the activation server (117) is arranged to repeatedly request presence indications for the set of registered user equipment from the presence service.

17. The cellular communication system of claim 1 wherein the underlay base station (105) is arranged to transmit a pilot signal when in the active mode and to not transmit the pilot signal when in the inactive mode.

18. The cellular communication system of claim 1 wherein the set of registered user equipment is a subset of user equipment authorised to be supported by the underlay base station (105).

19. A method of operation for a cellular communication system comprising a network supporting user equipment over a cellular air interface having a hierarchical cell arrangement with a plurality of overlay cells and underlay cells and at least one underlay base station (105) for supporting an underlay cell of the cellular communication system, the underlay base station (105) being associated with a set of registered user equipment registered for the underlay base station; the method comprising:
determining location indications for user equipment;
an activation server (117) of the network transmitting an activation message to the underlay base station (105) in response to a detection that a location indication for a first user equipment meets a first criterion and that the first user equipment is in the subset of registered user equipment; and
the underlay base station (105) switching from an inactive mode to an active mode in response to receiving the activation message;
wherein the underlay base station (105) is arranged to support user equipment of the underlay cell when in the active mode and to not support user equipment of the underlay cell when in the inactive mode.
